(19) United States
(12) Patent Application Publication
(10) Pub. No.: US 2026/0303130 A1
(43) Pub. Date: Oct. 1, 2026

(54) MILLIMETER WAVE MULTI-ACCESS POINT COMMUNICATION SYSTEM

(71) Applicant: Qiang Yu, Cupertino, CA (US)

(72) Inventor: Qiang Yu, Cupertino, CA (US)

(21) Appl. No.: 19/094,038

(22) Filed: Mar. 28, 2025

(51) Int. Cl. H04B 1/00; H04B 15/06

(52) U.S. Cl. CPC H04B 1/0078; H04B 15/06

(57) ABSTRACT

A millimeter wave (mm-wave) communication system is provided. The system comprises a plurality of access points and a plurality of client devices. A first access point comprises a first local oscillator with a first oscillating frequency; a first converter connected to the first local oscillator and configured to: convert a first mm-wave signal from a first client device to a first intermediate frequency signal using the first oscillating frequency; and convert a second mm-wave signal from a second client device to a second intermediate frequency signal using the first oscillating frequency; and a first intermediate frequency transceiver; and a first filter connected between the first converter and the first intermediate frequency transceiver, wherein the first filter is configured to: suppress the second intermediate frequency signal; and pass the first intermediate frequency signal to the first intermediate frequency transceiver.

### TECHNOLOGICAL FIELD

The present disclosure relates generally to a millimeter wave (mm-wave) multi-access point (AP) communication system, and in particular, to an mm-wave multi-AP communication system that can suppress or mitigate sidelobe interference or inter-AP interference.

### BACKGROUND

The deployment of mm-wave multi-AP systems may address the growing demand for high-bandwidth wireless communications and broad coverage. A deployment of an mm-wave multi-AP system may involve the proximate installation of multiple APs, each designed to cover a specific area or an angular region. However, this deployment may introduce interferences. One type of interference is sidelobe interference. For example, a client device may transmit mm-wave signals to an AP with a main lobe coverage area covering the client device. The mm-wave signals may be received by other APs'sidelobe coverage areas, causing sidelobe interference to other APs. Another type of interference is inter-AP interference. For example, in dense deployments of multiple APs, the client device may receive mm-wave signals from multiple APs concurrently, causing inter-AP interference to the client device.

Therefore, it would be desirable to have a solution that takes into account at least some of the issues discussed above, as well as other possible issues.

### BRIEF SUMMARY

Example embodiments of the present disclosure are directed to an mm-wave multi-AP communication system that can suppress or mitigate sidelobe interference and/or inter-AP interference. In some embodiments, the mm-wave multi-AP communication system includes a plurality of access points, and each of the plurality of access points have a local oscillator with a respective local oscillating frequency. In some embodiments, the respective local oscillating frequency maybe different for each of the plurality of access points. In some embodiments, some but not all of the plurality of access points may have different local oscillating frequencies.

In some embodiments, the mm-wave multi-AP communication system includes a plurality of client devices, and each of the plurality of client devices have a local oscillator with a respective local oscillating frequency. In some embodiments, the respective local oscillating frequency may be different for each of the plurality of client devices. In some embodiments, some but not all of the plurality of client devices may have different local oscillating frequencies.

Example embodiments of the present disclosure integrate or utilize a band pass filter or band select filter. The band pass filter or band select filter can be positioned between an up/down converter (UDC) and an intermediate-frequency (IF) transceiver for each of the APs and/or each of the client devices in the mm-wave multi-AP communication system. As described in details below, in some embodiments, an AP can employ a fixed intermediate frequency (IF) configuration and filter interferences or interfering signals based on the local oscillator (LO) frequency of the AP. In some embodiments, a client device can employ a fixed intermediate frequency (IF) configuration and filter interferences or interfering signals based on the local oscillator (LO) frequency of the client device. The solution in the present disclosure can effectively suppress or mitigate sidelobe interference and/or inter-AP interference.

The present disclosure thus includes, without limitation, the following example embodiments.

Some embodiments provide a millimeter wave (mm-wave) communication system. The mm-wave communication system comprises: a plurality of access points comprising a first access point and a second access point, and a plurality of client devices comprising a first client device and a second client device. The first access point comprises: a first local oscillator with a first oscillating frequency; a first converter connected to the first local oscillator and configured to: convert a first mm-wave signal from the first client device to a first intermediate frequency signal using the first oscillating frequency; and convert a second mm-wave signal from the second client device to a second intermediate frequency signal using the first oscillating frequency; and a first intermediate frequency transceiver; and a first filter connected between the first converter and the first intermediate frequency transceiver, wherein the first filter is configured to: suppress the second intermediate frequency signal; and pass the first intermediate frequency signal to the first intermediate frequency transceiver.

In some embodiments, the second access point comprises: a second local oscillator with a second oscillating frequency; a second converter connected to the second local oscillator and configured to: convert the first mm-wave signal from the first client device to a third intermediate frequency signal using the second oscillating frequency; and convert the second mm-wave signal from the second client device to a fourth intermediate frequency signal using the second oscillating frequency; and a second intermediate frequency transceiver; and a second filter connected between the second converter and the second intermediate frequency transceiver, wherein the second filter is configured to: suppress the third intermediate frequency signal; and pass the fourth intermediate frequency signal to the second intermediate frequency transceiver.

In some embodiments, the first oscillating frequency and the second oscillating frequency are different frequencies.

In some embodiments, the first mm-wave signal and the second mm-wave signal have different frequency bands with different center frequencies.

In some embodiments, the first intermediate frequency signal and the fourth intermediate frequency signal have the same frequency band with the same center frequency.

In some embodiments, the first filter and the second filter are band pass filters with the same pass frequency band.

In some embodiments, the first intermediate frequency signal and the fourth intermediate frequency signal have different frequency bands with different center frequencies.

In some embodiments, the first filter and the second filter are band pass filters with different pass frequency bands.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example embodiment described herein. This disclosure is intended to be read holistically such that any separable features or elements of the disclosure, in any of its aspects and example embodiments, should be viewed as combinable unless the context of the disclosure clearly dictates otherwise.

It will therefore be appreciated that this Brief Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other example embodiments, aspects and advantages will become apparent from the following detailed description taken in conjunction with the accompanying figures which illustrate, by way of example, the principles of some described example embodiments.

### BRIEF DESCRIPTION OF THE FIGURE(S)

Having thus described example embodiments of the disclosure in general terms, reference will now be made to the accompanying figures, which are not necessarily drawn to scale, and wherein:

FIG. 1 illustrates an mm-wave multi-AP communication system, according to some embodiments of the present disclosure;

FIG. 2 illustrates a first access point of an mm-wave multi-AP communication system, according to some embodiments of the present disclosure; and

FIG. 3 illustrates a second access points of an mm-wave multi-AP communication system, according to some embodiments of the present disclosure.

### DETAILED DESCRIPTION

Some embodiments of the present disclosure will now be described more fully hereinafter with reference to the accompanying figures, in which some, but not all embodiments of the disclosure are shown. Indeed, various embodiments of the disclosure may be embodied in many different forms and should not be construed as limited to the embodiments set forth herein; rather, these example embodiments are provided so that this disclosure will be thorough and complete, and will fully convey the scope of the disclosure to those skilled in the art. For example, unless otherwise indicated, reference something as being a first, second or the like should not be construed to imply a particular order. Like reference numerals refer to like elements throughout.

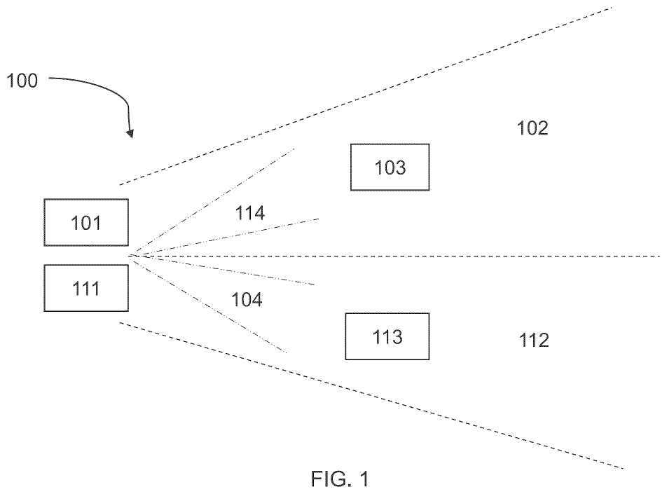

FIG. 1 illustrates an mm-wave multi-AP communication system 100, according to some embodiments of the present disclosure. As shown, the system 100 may include a plurality of APs, such as 101 and 111. AP 101 may have a coverage area 102, and AP 111 may have a coverage area 112. The coverage area 102 may be a main lobe coverage of AP 101, and the coverage area 112 may be a main lobe coverage of AP 111. The system 100 may also include a plurality of client devices, such as 103 and 113. Client device 103 may be within the coverage area 102 covered by AP 101, and client device 113 may be within the coverage area 112 covered by AP 111. In some embodiments, an AP may be an access point or small cell, and a client device may be a customer premises equipment (CPE).

In some embodiments, as shown in FIG. 1, AP 101 may have a sidelobe coverage 104, and AP 111 may have a sidelobe coverage 114. The client device 103 may transmit mm-wave signals to AP 101, and client device 113 may transmit mm-wave signals to AP 111. While client device 113 is within the coverage area 112, client device 113 may be close to or near the coverage area 104. Thus, when transmitting mm-wave signals to AP 111, AP 101 may also receive the mm-wave signals from client device 113 by AP 101's sidelobe coverage 104, causing sidelobe interference to AP 101. Similarly, AP 111 may receive the mm-wave signals from client device 103 by AP 111's sidelobe coverage 114, causing sidelobe interference to AP 111.

In some embodiments, the client device 103 may receive mm-wave signals from AP 101, and client device 113 may receive mm-wave signals from AP 111. While client device 113 is within the coverage area 112, client device 113 may be close to or near the coverage area 104. Thus, when receiving mm-wave signals from AP 111, client device 113 may also receive the mm-wave signals from AP 101's sidelobe coverage 104, causing sidelobe interference to client device 113. Similarly, client device 103 may receive the mm-wave signals from AP 111's sidelobe coverage 114, causing sidelobe interference to client device 103.

In some embodiments, client device 103 may receive mm-wave signals from AP 101, and client device 113 may receive mm-wave signals from AP 111. AP 101 and 111 may be positioned close to each other, thus client device 103 may receive mm-wave signals from AP 101 and AP 111 concurrently, and the mm-wave signals from AP 111 may cause inter-AP interference to client device 103. Similarly, client device 113 may receive mm-wave signals from AP 111 and AP 101 concurrently, and the mm-wave signals from AP 101 may cause inter-AP interference to client device 113. In some embodiments, AP 101's main lobe coverage area 102 and AP 111's main lobe coverage area 112 may have an overlapping area. Client device 113 may be in the overlapping area. Thus, AP 101 may receive the mm-wave signals from client device 113 by AP 101's main lobe coverage area 102, causing interference to AP 101.

In some embodiments, the mm-wave multi-AP communication system 100 may include more than two APs as shown in FIG. 1. For example, the system 100 may include 3 APs, and each of the 3 APs may cover a sector area with 120 degree, or the system 100 may include 6 APs, and each of the 6 APs may cover a sector area with 60 degree. In some embodiments, the mm-wave multi-AP communication system 100 may include more than two client devices as shown in FIG. 1. A client device may transmit mm-wave signals, which may be received by multiple APs'sidelobe coverage areas, causing sidelobe interference to those APs. Similarly, a client device may receive mm-wave signals from more than two APs concurrently, causing inter-AP interference to the client device.

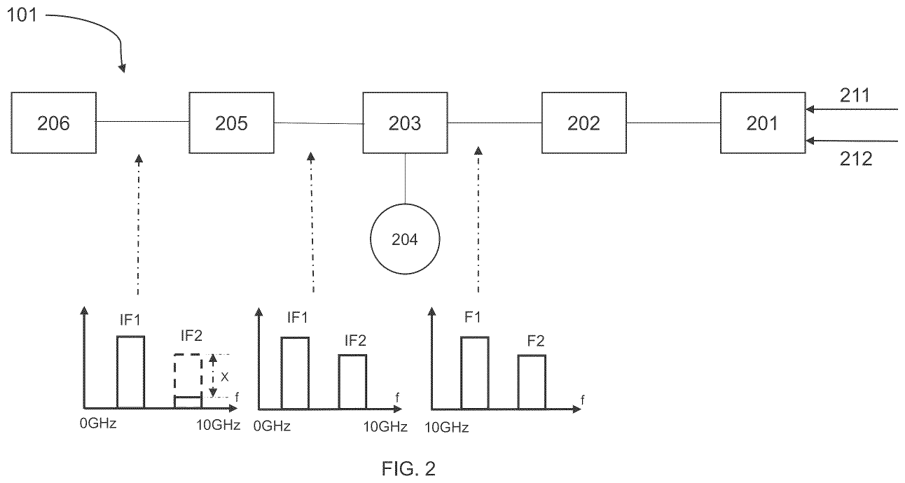

FIG. 2 illustrates a first AP 101 of the mm-wave multi-AP communication system 100, according to some embodiments of the present disclosure. AP 101 includes an antenna array 201. The antenna array 201 may receive an mm-wave signal 211 from the client device 103, which is within the main lobe coverage area 102 of AP 101. The antenna array 201 may also receive an mm-wave signal 212 from the client device 113, which is within the main lobe coverage area 112 of AP 111. The client device 113 may be near or close to the main lobe coverage area 102 or sidelobe coverage area 104 of AP 101, thus, while the client device 113 may intend to transmit the mm-wave signal 212 only to AP 111, at least part of the mm-wave signal 212 may be also transmitted to AP 101. The mm-wave signal 212 or at least part of the mm-wave signal 212 received by the antenna array 201 or AP 101 may cause sidelobe interference to AP 101, and the sidelobe interference to AP 101 may be suppressed or mitigated. In some embodiments, the mm-wave signal 211 and the mm-wave signal 212 have different frequency bands with different center frequencies.

In some embodiments, a beamforming integrated circuit or component 202 may perform beamforming on mm-wave signal 211 and mm-wave signal 212 received by the antenna array 201. The beamforming integrated circuit 202 and antenna array 201 may work together to enhance or maximize antenna main lobe gain and directivity, also may generate some sidelobes. In some embodiments, as shown in FIG. 2, in frequency domain, the beamformed mm-wave signal 211 may be denoted as F1 and the beamformed mm-wave signal 212 may be denoted as F2. In some embodiments, F1 and F2 have different frequency bands with different center frequencies. For example, F1 may have a center frequency of 26.5 GHz with a bandwidth of 320 MHz (i.e., 160 MHz bandwidth below 26.5 GHz and 160 MHz bandwidth above 26.5 GHz) and F2 may have a center frequency of 27.5 GHz with a bandwidth 320 MHz. In this example, the frequency band of F1 is the working mm-wave frequency band for AP 101 and client device 103, and the frequency band of F2 is the working mm-wave frequency band for AP 111 and client device 113.

In some embodiments, after beamforming, the beamforming integrated circuit 202 may pass or transmit the mm-wave signals F1 and F2 to a converter 203, e.g., an up/down converter. The converter 203 is connected to a local oscillator 204 with a first oscillating frequency LO1. In one example, LO1 may be 20 GHz. The converter 203 can convert the mm-wave signal F1 from the client device 103 to a first intermediate frequency signal using LO1, and convert the mm-wave signal F2 from client device 113 to a second intermediate frequency signal using LO1. As shown in FIG. 2, in frequency domain, the first intermediate frequency signal may be denoted as IF1 and the second intermediate frequency signal may be denoted as IF2. In this way, sidelobe interference caused by F2 may be down-converted to IF2.

In one example, after the converting by the converter 203, IF1 may have a center frequency of 6.5 GHz (i.e., F1−LO1=26.5−20) with a bandwidth of 320 MHz, and IF2 may have a center frequency of 7.5 GHz (i.e., F2−LO1=27.5−20) with a bandwidth of 320 MHz. In this example, the frequency band of IF1 is the working intermediate frequency band for AP 101, and thus IF2 can cause interference—to an intermediate frequency transceiver 206 of AP 101.

In some embodiments, a filter 205 can be connected between the converter 203 and the intermediate frequency transceiver 206. The filter 205 can be a band pass filter or band select filter. The pass frequency band of the filter 205 may include the intermediate frequency band of IF1, e.g., a center frequency of 6.5 GHz with a bandwidth of 320 MHz. The pass frequency band of the filter 205 does not include the intermediate frequency band of IF2, e.g., a center frequency of 7.5 GHz with a bandwidth of 320 MHz. Thus, as shown in FIG. 2 the filter 205 can suppress IF2. In some embodiments, the filter 205 can suppress IF2 by X dB. In one example, X=20 dB or more. On the other hand, the filter 205 can pass IF1 to the intermediate frequency transceiver 206. In this way, sidelobe interference caused by F2 to AP 101 or interference caused by IF2 to the intermediate frequency transceiver 206 can be mitigated.

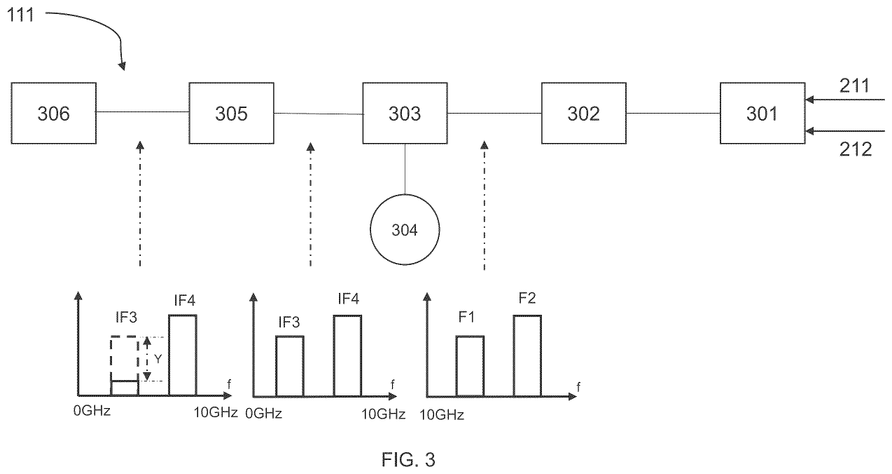

FIG. 3 illustrates a second AP 111 of the mm-wave multi-AP communication system 100, according to some embodiments of the present disclosure. Similarly as described above with respect to FIG. 2, AP 111 includes an antenna array 301. The antenna array 301 may receive the mm-wave signal 212 from the client device 113, which is within the main lobe coverage area 112 of AP 111. The antenna array 301 may also receive the mm-wave signal 211 from the client device 103, which is within the main lobe coverage area 102 of AP 101. The client device 103 may be near or close to the main lobe coverage area 112 or sidelobe coverage area 114 of AP 111, thus, while the client device 103 may intend to transmit the mm-wave signal 211 only to AP 101, at least part of the mm-wave signal 211 may be also transmitted to AP 111. The mm-wave signal 211 or at least part of the mm-wave signal 211 received by the antenna array 301 or AP 111 may cause sidelobe interference to AP 111, and the sidelobe interference to AP 111 may be suppressed or mitigated.

In some embodiments, a beamforming integrated circuit or component 302 may perform beamforming on mm-wave signal 211 and mm-wave signal 212 received by the antenna array 301. Similarly as shown in FIG. 2, in FIG. 3, in frequency domain, the beamformed mm-wave signal 211 may be denoted as F1 and the beamformed mm-wave signal 212 may be denoted as F2. In some embodiments, F1 and F2 have different frequency bands with different center frequencies. For example, F1 may have a center frequency of 26.5 GHz with a bandwidth of 320 MHz (i.e., 160 MHz bandwidth below 26.5 GHz and 160 MHz bandwidth above 26.5 GHz) and F2 may have a center frequency of 27.5 GHz with a bandwidth 320 MHz. In this example, the frequency band of F1 is the working mm-wave frequency band for AP 101 and client device 103, and the frequency band of F2 is the working mm-wave frequency band for AP 111 and client device 113.

In some embodiments, after beamforming, the beamforming integrated circuit 302 may pass or transmit the mm-wave signals F1 and F2 to a converter 303, e.g., an up/down converter. The converter 303 is connected to a local oscillator 304 with a first oscillating frequency LO2. In one example, LO2 may be 21 GHz, and different from LO1. The converter 303 can convert the mm-wave signal F1 from the client device 103 to a third intermediate frequency signal using LO2, and convert the mm-wave signal F2 from client device 113 to a fourth intermediate frequency signal using LO2. As shown in FIG. 3, in frequency domain, the third intermediate frequency signal may be denoted as IF3 and the fourth intermediate frequency signal may be denoted as IF4. In this way, sidelobe interference caused by F3 may be down-converted to IF3.

In one example, after the converting by the converter 303, IF3 may have a center frequency of 5.5 GHz (i.e., F1−LO2=26.5−21) with a bandwidth of 320 MHz, and IF4 may have a center frequency of 6.5 GHz (i.e., F2−LO2=27.5−21) with a bandwidth of 320 MHz. In this example, the frequency band of IF4 is the working intermediate frequency band for AP 111, and thus IF3 can cause interference to an intermediate frequency transceiver 306 of AP 111. In some embodiments, IF1 and IF4 have the same frequency band with the same center frequency, e.g., a center frequency of 6.5 GHz with a bandwidth of 320 MHz.

In some embodiments, a filter 305 can be connected between the converter 303 and the intermediate frequency transceiver 306. The filter 305 can be a band pass filter or band select filter. The pass frequency band of the filter 305 may include the intermediate frequency band of IF4, e.g., a center frequency of 6.5 GHz with a bandwidth of 320 MHz. In some embodiments, the filter 205 and filter 305 are both band pass filters with the same pass frequency band, e.g., a center frequency of 6.5 GHz with a bandwidth of 320 MHz. The pass frequency band of the filter 305 does not include the intermediate frequency band of IF3, e.g., a center frequency of 5.5 GHz with a bandwidth of 320 MHz. Thus, as shown in FIG. 3 the filter 305 can suppress IF3. In some embodiments, the filter 305 can suppress IF3 by Y dB. In one example, Y=20 dB or more. On the other hand, the filter 305 can pass IF4 to the intermediate frequency transceiver 306. In this way, sidelobe interference caused by F3 to AP 111 or interference caused by IF3 to the intermediate frequency transceiver 306 can be mitigated.

In some embodiments, IF1 and the IF4 may have different frequency bands with different center frequencies. For example, F1 may have a center frequency of 26.5 GHz with a bandwidth of 320 MHz. For AP 101, LO1 may be 20 GHz. The converter 203 can convert the mm-wave signal F1 from the client device 103 to a first intermediate frequency signal IF1 using LO1. IF1 may have a center frequency of 6.5 GHz (i.e., F1−LO1=26.5−20) with a bandwidth of 320 MHz. F2 may have a center frequency of 27.5 GHz with a bandwidth of 320 MHz. For AP 111, LO2 may be 22 GHz. The converter 303 can convert the mm-wave signal F2 from the client device 113 to a fourth intermediate frequency signal IF4 using LO2. IF4 may have a center frequency of 5.5 GHz (i.e., F2−LO2=27.5−22) with a bandwidth of 320 MHz. In this example, the converter 303 can also convert the mm-wave signal F1 from the client device 103 to a third intermediate frequency signal IF3 using LO2. IF3 may have a center frequency of 4.5 GHz (i.e., F1−LO2=26.5−22) with a bandwidth of 320 MHz.

In some embodiments, the filter 205 and the filter 305 are band pass filters with different pass frequency bands. For example, as described in the above paragraph, IF1 may have a center frequency of 6.5 GHz with a bandwidth of 320 MHz, and the pass frequency band of the filter 205 may include the intermediate frequency band of IF1, e.g., a center frequency of 6.5 GHz with a bandwidth of 320 MHz. IF4 may have a center frequency of 5.5 GHz with a bandwidth of 320 MHz, and the pass frequency band of the filter 305 may have a different pass frequency band from filter 205. The pass frequency band of the filter 305 may include the intermediate frequency band of IF4, e.g., a center frequency of 5.5 GHz with a bandwidth of 320 MHz.

In some embodiments, similarly as described above with respect to AP 101 and AP 111, the client devices can be arranged with different local oscillators as well to mitigate inter-AP interference. For example, the frequency band of F1 is the working mm-wave frequency band for AP 101 and client device 103, and the frequency band of F2 is the working mm-wave frequency band for AP 111 and client device 113. F1 may have a center frequency of 26.5 GHz with a bandwidth of 320 MHz, and F2 may have a center frequency of 27.5 GHz with a bandwidth of 320 MHz. The client device 103 may receive an mm-wave signal from AP 101 (intended mm-wave signal), and an mm-wave signal from AP 111 (inter-AP interference signal). The client device 103 may convert the intended mm-wave signal to an intended intermediate frequency signal (e.g., a center frequency of 6.5 GHz with a bandwidth of 320 MHz) using an local oscillator of client device 103 (e.g., LO=20 GHz for client device 103), and convert the inter-AP interference signal to another intermediate frequency signal (e.g., a center frequency of 7.5 GHz with a bandwidth of 320 MHz), which will be suppressed or mitigated by a filter of the client device 103. The filter of the client device 103 may include the intermediate frequency band of the intended intermediate frequency signal but does not include the intermediate frequency band of the other intermediate frequency signal.

Similarly, the client device 113 may receive an mm-wave signal from AP 111 (intended mm-wave signal), and an mm-wave signal from AP 101 (inter-AP interference signal). The client device 113 may convert the intended mm-wave signal to an intended intermediate frequency signal (e.g., a center frequency of 6.5 GHz with a bandwidth of 320 MHz) using an local oscillator of client device 113 (e.g., LO=21 GHz for client device 113), and convert the inter-AP interference signal to another intermediate frequency signal (e.g., a center frequency of 5.5 GHz with a bandwidth of 320 MHz), which will be suppressed or mitigated by a filter of the client device 113. The filter of the client device 113 may include the intermediate frequency band of the intended intermediate frequency signal but does not include the intermediate frequency band of the other intermediate frequency signal.

In some embodiments, the mm-wave multi-AP communication system 100 may include more than two APs and/or more than two client devices. In some embodiments, each of the APs may have a local oscillator with a different oscillating frequency. For example, the system 100 may include three APs (e.g., AP1, AP2 and AP3) and each of the 3 APs may cover a sector area with 120 degree. Each of the 3 APs may have a local oscillator with a different oscillating frequency, e.g., 20 GHz for AP1, 21 GHz for AP2 and 22GHz for AP3. Sidelobe interference to the three or more APs can be suppressed similarly as described above.

Similarly, each of the client devices may have a local oscillator with a different oscillating frequency. For example, the system 100 may include three client devices (e.g., client device 1, client device 2 and client device 3). Each of the 3 client devices may have a local oscillator with a different oscillating frequency, e.g., 20 GHz for client device 1, 21 GHz for client device 2 and 22 GHz for client device 3. Inter-AP interference to the three or more client devices can be suppressed similarly as described above.

In some embodiments, some but not all of the APs may have a local oscillator with a different oscillating frequency. For example, the system 100 may include four APs (e.g., AP1, AP2, AP3 and AP4) and each of the 4 APs may cover a sector area with 90 degree. AP1 may have a local oscillator with an oscillating frequency of 20 GHz, and AP2 may have a local oscillator with an oscillating frequency of 21 GHz. For AP3 and AP4, AP3 may have a local oscillator with an oscillating frequency of 20 GHz (the same as AP1), and AP4 may have a local oscillator with an oscillating frequency of 21 GHz (the same as AP2). Sidelobe interference to the three or more APs can be suppressed similarly as described above.

Similarly, some but not all of the client devices may have a local oscillator with a different oscillating frequency. For example, the system 100 may include four client devices (e.g., client device 1, client device 2, client device 3 and client device 4). Client device 1 may have a local oscillator with an oscillating frequency of 20 GHz, and client device 2 may have a local oscillator with an oscillating frequency of 21 GHz. For client device 3 and client device 4, client device 3 may have a local oscillator with an oscillating frequency of 20 GHz (the same as client device 1), and client device 4 may have a local oscillator with an oscillating frequency of 21 GHz (the same as client device 2). Inter-AP interference to the three or more client devices can be suppressed similarly as described above.

Many modifications and other embodiments of the disclosure set forth herein will come to mind to one skilled in the art to which the disclosure pertains having the benefit of the teachings presented in the foregoing description and the associated figures. Therefore, it is to be understood that the disclosure is not to be limited to the specific embodiments disclosed and that modifications and other embodiments are intended to be included within the scope of the appended claims. Moreover, although the foregoing description and the associated figures describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A millimeter wave (mm-wave) communication system, comprising:
a plurality of access points comprising a first access point and a second access point, and
a plurality of client devices comprising a first client device and a second client device;
wherein the first access point comprises:
a first local oscillator with a first oscillating frequency;
a first converter connected to the first local oscillator and configured to:
convert a first mm-wave signal from the first client device to a first intermediate frequency signal using the first oscillating frequency; and
convert a second mm-wave signal from the second client device to a second intermediate frequency signal using the first oscillating frequency; and
a first intermediate frequency transceiver; and
a first filter connected between the first converter and the first intermediate frequency transceiver, wherein the first filter is configured to:
suppress the second intermediate frequency signal; and
pass the first intermediate frequency signal to the first intermediate frequency transceiver.

2. The mm-wave communication system of claim 1, wherein the second access point comprises:
a second local oscillator with a second oscillating frequency;
a second converter connected to the second local oscillator and configured to:
convert the first mm-wave signal from the first client device to a third intermediate frequency signal using the second oscillating frequency; and
convert the second mm-wave signal from the second client device to a fourth intermediate frequency signal using the second oscillating frequency; and
a second intermediate frequency transceiver; and
a second filter connected between the second converter and the second intermediate frequency transceiver, wherein the second filter is configured to:
suppress the third intermediate frequency signal; and
pass the fourth intermediate frequency signal to the second intermediate frequency transceiver.

3. The mm-wave communication system of claim 2, wherein the first oscillating frequency and the second oscillating frequency are different frequencies.

4. The mm-wave communication system of claim 1, wherein the first mm-wave signal and the second mm-wave signal have different frequency bands with different center frequencies.

5. The mm-wave communication system of claim 2, wherein the first intermediate frequency signal and the fourth intermediate frequency signal have the same frequency band with the same center frequency.

6. The mm-wave communication system of claim 2, wherein the first filter and the second filter are band pass filters with the same pass frequency band.

7. The mm-wave communication system of claim 2, wherein the first intermediate frequency signal and the fourth intermediate frequency signal have different frequency bands with different center frequencies.

8. The mm-wave communication system of claim 2, wherein the first filter and the second filter are band pass filters with different pass frequency bands.
